(19) United States
(12) Patent Application Publication
(10) Pub. No.: US 2024/0301146 A1
(43) Pub. Date: Sep. 12, 2024

(54) Polymer-Nanocarbon Composites

(71) Applicant: ExxonMobil Technology and Engineering Company, Annandale, NJ (US)

(72) Inventors: Adam B. Burns, Maplewood, NJ (US); Huaxing Zhou, Warwick, PA (US); Ozcan Altintas, Franklin Park, NJ (US); Abhimanyu O. Patil, Westfield, NJ (US); Bharath Natarajan, Basking Ridge, NJ (US)

(73) Assignee: ExxonMobil Technology and Engineering Company, Annandale, NJ (US)

(21) Appl. No.: 18/637,198

(22) Filed: Apr. 16, 2024

Related U.S. Application Data
(63) Continuation of application No. PCT/US2022/075571, filed on Aug. 29, 2022.
(60) Provisional application No. 63/261,472, filed on Sep. 22, 2021.

(51) Int. Cl. C08G 83/00; C01B 32/174

(52) U.S. Cl. CPC C08G 83/001; C01B 32/174

(57) ABSTRACT

Polymer-nanocarbon composites, fiber-reinforced polymer composites, carbon matrix-nanocarbon composites, fiber-reinforced carbon matrix-nanocarbon composites, and methods for their manufacture are provided. The composites comprise one or more nanocarbon materials, optionally comprise fibers, and are produced from one or more polymers containing aromatic hydrocarbon moieties and/or aromatic heterocyclic moieties. The composite matrices may comprise thermoplastics or thermosets and may find use in, for example, infrastructure applications.

### FIELD OF THE INVENTION

This disclosure relates to polymer-nanocarbon composites and to methods for their manufacture. The polymer-nanocarbon composite comprise one or more nanocarbon materials and one or more polymers containing aromatic hydrocarbon moieties and/or aromatic heterocyclic moieties. The composite matrices may comprise thermoplastics or thermosets and may find use in a wide range of applications, for example, infrastructure applications.

### BACKGROUND OF THE INVENTION

Allotropes of carbon with at least one nanoscale dimension, including single and multiwalled carbon nanotubes (CNTs), nanofibers, graphene, fullerenes, activated carbon, carbon black, carbon foams, other polymeric forms of carbon, and articles made therefrom, collectively referred to as nanocarbons, have long shown great promise as filler materials in polymer-matrix composites. Nanocarbon fillers have been shown to confer enhanced mechanical, electrical, and thermal properties to polymer-nanocarbon composites (PNCCs) even at loadings below 1%. Sec, for example, Blake et al. J. Am. Chem. Soc. 2004, 126, 10226-10227; Shi et al. Nanotechnology 2007, 18, 375704 and Fukushima etal. Science 2003, 300, 2072-2074.

CNTs, in particular, have attracted attention due to their outstanding mechanical, thermal, and electrical properties. High strength (100 times stronger than steel) and modulus (about 1 TPa), high thermal conductivity (about twice as high as diamond), excellent electrical capacity (1000 times higher than copper), and thermal stability (2800° C. in vacuum) in combination with low density and high aspect ratio, make CNTs one of the most promising candidates to reinforce polymer nanocomposites. For example, Blake et al. (supra) and Shi et al. (supra) reported two-fold improvements in the yield strength and toughness of PNCCs with just 0.6 and 0.5 volume percent CNTs added to the neat polymer.

However, realizing these benefits depends strongly on the dispersion state of the nanocarbon in the polymeric matrix. In general, aggregated fillers cannot provide the same property enhancements as well-dispersed fillers for a given filler content. At low filler fractions, the point at which the filler forms a continuous network spanning the entire sample volume, i.e., the percolation threshold, is the critical condition above which the macroscopic properties (electrical, thermal, mechanical, etc.) are manifestly improved. The percolation threshold, in turn, is a strong function of the dispersion state and particle shape anisotropy (Schilling et al. EPL 2015, 111, 56004). Filler aggregates, e.g., stacks of graphene, bundles of CNTs, or clusters of fullerenes, behave as single, compact entities, which increases the effective percolation threshold. At a minimum, this means that PNCCs in which nanocarbon aggregation occurs will require more filler to match the performance of analogous materials in which the filler is well dispersed. In some instances, simply increasing the filler fraction cannot overcome the detrimental effects of aggregation.

At higher filler loadings, the infiltration of solvents and polymers can also cause the filler to aggregate via mechanisms such as elastocapillary coalescence. Again, this reduces the efficacy of the filler. Filler aggregation dramatically reduces the interfacial contact area between the two materials, which has a deleterious effect on the mechanical performance. Furthermore, difficulties in the processing often give rise to voids in the final composite.

Nanocarbons have a strong tendency to aggregate and phase separate from surrounding media; thus, fabrication of PNCCs with well-dispersed nanocarbons remains a primary barrier to their wide-spread use. Disaggregation and dispersion of nanocarbons is commonly facilitated by a liquid medium and either mechanical or sonic agitation. PNCCs with low filler contents (ca. 1%) are subsequently prepared therefrom by combining with one the following three substances: (1) a polymer solution, (2) a solid polymer or polymer melt, or (3) a liquid polymer precursor, which may contain solvent, and is subsequently cured. These mixtures are processed as schematized in FIGS. 1, 2 and 3, respectively. All of these workflows typically require solvent removal, which can have adverse effects on the final composite, such as re-aggregation of the fdler or void formation. Moreover, carrying the solvent through the process increases the capital and operating costs. These issues could be avoided if the nanocarbon could be dispersed directly into a liquid polymer precursor in the absence or substantial absence of any non-polymerizable solvents, obviating the need for the solvent removal step. However, the dispersibility threshold for CNTs in many organic liquids is quite low (<0.1 percent by volume), see, for example, Bergin et al. ACS Nano 2009, 3, 2340-2350 and Chiou et al. Proc. Natl. Acad. Sci. U.S.A. 2018, 115, 5703-5708. Incompatibility between the aromatic nanocarbon and the polymer and/or polymer precursor may also negatively influence the properties of the resulting PNCC.

Several strategies have been investigated for improving the dispersibility of nanocarbons in solvents and, ultimately, polymers. Compatibilizers can be used to modulate the interfacial interactions between nanocarbons and the surrounding media. Surfactants and macromolecules (e.g., synthetic polymers and DNA) have been used to improve the dispersibility of nanocarbons in small-molecule solvents, but are not amenable to PNCC fabrication. Blake et al. (supra), Shi et al. (supra), and others promoted dispersion in solvents and polymer matrices by chemically grafting polymers to the surface of nanocarbons. Specialty solvents, such as molten organic salts (ionic liquids), Fukushima et al. (supra), or super acids (Davis et al. Nat. Nanotechnol. 2009, 4, 830-834) have also been used to disperse CNTs. Ionic liquids and super acids may improve dispersion, but these solvents are incompatible with many polymers and are difficult to remove during down-stream processing. Moreover, they present serious safety hazards.

Chiou etal., (supra) demonstrated homogeneous CNT dispersions in cresols (isomerically pure cresols, isomeric mixtures of cresols, and mixed cresols with 10 wt. % phenol) with CNT concentrations up to tens of weight percent.

PNCCs with high filler fractions (exceeding 10% nanocarbon) may be fabricated by infiltrating freestanding nanocarbon material, such as a yarn, fabric, mat, paper, or foam with a liquid. Freestanding nanocarbon materials inherently yield PNCCs with higher filler fractions than the dispersion process described above. The liquid may be a solution containing polymer precursors (uncured resin) see Wang et al. Nanotechnology 2013, 24, 015704, Wang et al. Mater. Res. Lett. 2013, 1, 19-25 and Tan e/a/. Carbon 2019, 150, 489-504 or a neat polymer precursor see Mora et al. Compos. Sci Technol. 2009, 69, 1558-1563, Vilatela et al. Carbon 2012, 50, 1227-1234 and Mikhalchan etal. J. Mater. Sci. 2016, 51, 10005-10025. The polymer matrix is subsequently formed by removing the solvent (if present), e.g., by heating and/or by applying vacuum or through coagulation with a non-solvent (Tan et al. supra) and curing the precursor (see scheme in FIG. 4). The resulting materials are stiff, strong, and light-weight (particularly if the nanocarbon filler is anisotropic, e.g., CNTs, and oriented) and make excellent candidates to supplant glass and carbon fiber-reinforced polymer composites, and even more traditional building materials, in structural applications. However, the performance of these materials is limited by the significant void fraction which results from incomplete infiltration. Incomplete infiltration may result from several compounding factors including: (1) thermodynamic incompatibility between the liquid and the nanocarbon, (2) high solution viscosity, or (3) size exclusion of the polymer chains or precursors. Voiding may be further exacerbated by solvent removal. At best, these voids lower the apparent stiffness and strength; at worst, they may function as defects, stress concentrators, and ultimately crack nucleation sites. If solvent removal is insufficient, the residual solvent may plasticize the polymer, diminishing the mechanical performance.

In view of the foregoing a need exists to provide improved polymer-nanocarbon composites and methods for their preparation which overcome or ameliorate one or more of the aforementioned problems.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY OF THE INVENTION

Disclosed herein are polymer-nanocarbon composites and methods for their preparation. The methods involve using aromatic hydrocarbon and/or aromatic heterocyclic liquids as both the dispersing or infiltrating liquid and the polymer precursor. As nanocarbon materials are highly aromatic (most of the carbon atoms are sp² hybridized), aromatic hydrocarbon and/or aromatic heterocyclic liquids, and derivatives thereof, exhibit superior compatibility with nanocarbon materials.

In one aspect, the present disclosure provides a polymer-nanocarbon composite, said polymer-nanocarbon composite comprising one or more nanocarbon materials and one or more polymers, said polymers comprising aromatic hydrocarbon moieties and/or aromatic heterocyclic moieties.

In some embodiments, the one or more nanocarbon materials comprise one or more of carbon nanotubes, carbon nanofibers, graphene, fullerenes, activated carbon, carbon black and carbon foams.

In some embodiments, the one or more nanocarbon materials are dispersed within the polymer-nanocarbon composite.

In some embodiments, the one or more nanocarbon materials are distributed throughout the polymer-nanocarbon composite.

In some embodiments, the amount of the one or more nanocarbon materials may be up to about 70 vol. %, based on the total volume of the polymer-nanocarbon composite.

In some embodiments, the one or more nanocarbon materials have at least one dimension in a size ranging from about 0.2 nm to about 100 nm. In some embodiments, the polymer-nanocarbon composite has a void fraction of less than about 5 vol. % based on the total volume of the polymer-nanocarbon composite, as measured by ASTM D3172 Method I. In some embodiments, the polymer-nanocarbon composite has a void fraction of less than about 4 vol. %, or less than about 2 vol. %, or less than about 1 vol. %, or less than about 0.5 vol. %, or less than about 0.1 vol. %, based on the total volume of the polymer-nanocarbon composite, as measured by ASTM D3172 Method I.

In some embodiments, the amount of volatiles in the polymer-nanocarbon composite is less than about 10 wt. %, or less than about 5 wt. %, or less than about 2 wt. %, or less than about 1 wt. %, or less than about 0.5% wt. %, or less than about 0.2 wt. %.

In some embodiments, the amount of extractables in the polymer-nanocomposite is less than about 10 wt. %, or less than about 5 wt. %, or less than about 2 wt. %, or less than about 1 wt. %, or less than about 0.5% wt. %, or less than about 0.2 wt. %.

In some embodiments, the composite is derived from a composition comprising one or more nanocarbon materials and one or more aromatic hydrocarbons and/or aromatic heterocyclics, wherein said composition comprises less than about 10 wt. % solvent, or less than about 5 wt. %, or less than about 4 wt. %, or less than about 3 wt. %, or less than about 2 wt. %, or less than about 1 wt. %, based on the total weight of nanocarbon materials, one or more aromatic hydrocarbons and/or aromatic heterocyclics, and solvent.

In some embodiments, the aromatic hydrocarbon moieties and aromatic heterocyclic moieties comprise one or more monocyclic aromatic moieties, one or more polycyclic aromatic moieties and mixtures thereof.

In some embodiments, the one or more polymers comprise a plurality of different monocyclic aromatic moieties and/or polycyclic aromatic moieties.

In some embodiments, the average molecular weight of aromatic hydrocarbon moieties and/or aromatic heterocyclic moieties is between about 50 Daltons and about 1200 Daltons, or between about 150 and about 1200 Daltons, or between about 300 and about 1200 Daltons, or between about 400 and about 1200 Daltons, or between about 600 and about 900 Daltons, or between about 650 and about 850 Daltons, or between about 50 and 300 Daltons.

In some embodiments, the one or more aromatic hydrocarbon moieties and/or aromatic heterocyclic moieties are linked via aryl-aryl bonds, aryl-heteroaryl bonds, heteroaryl-heteroaryl bonds and combinations thereof.

Additionally, or alternatively, the one or more aromatic hydrocarbon moieties and/or aromatic heterocyclic moieties are linked via one or more linking groups.

In some embodiments, the one or more linking groups comprise one or more aliphatic groups.

In some embodiments, the one or more linking groups comprise one or more aromatic rings.

In some embodiments, the one or more linking groups comprise one or more heteroatoms.

In some embodiments, the one or more aromatic heterocyclic moieties comprise one or more ring atoms selected from the group consisting of nitrogen, sulfur, and oxygen.

In some embodiments, at least some of the aromatic hydrocarbon moieties and/or aromatic heterocyclic moieties further comprise one or more functional groups comprising one or more of oxygen, nitrogen, or sulfur atoms, wherein said functional groups are present as a substituent or within a substituent on an aromatic or aliphatic carbon atom.

In some embodiments, the one or more functional groups comprise one or more alcohols, aldehydes, amines, amides, acids, alkenes, alkynes, azides, carbonates, esters, ethers, halides, ketones, nitro groups, phenols, thiols, sulfonyl, and sulfonate.

In some embodiments, at least some of the one or more nanocarbon materials are linked to at least some of the aromatic hydrocarbon moieties and/or aromatic heterocyclic moieties via arylaryl bonds, aryl-heteroaryl bonds, and combinations thereof.

In some embodiments, additionally, or alternatively, at least some of the one or more nanocarbon materials are linked to at least some of the aromatic hydrocarbon moieties and/or aromatic heterocyclic moieties via one or more linking groups.

In some embodiments, the one or more linking groups comprise at least one aromatic ring.

In some embodiments, the one or more linking groups comprise one or more heteroatoms.

In some embodiments, the one or more nanocarbon materials further comprise one or more functional groups comprising one or more of oxygen, nitrogen, or sulfur atoms, wherein said functional groups are present as a substituent or within a substituent on an aromatic carbon of the nanocarbon material.

In some embodiments, the one or more functional groups comprises one or more of alcohols, aldehydes, amines, amides, acids, alkenes, alkynes, azides, arenes, carbonates, esters, ethers, halides, ketones, nitro groups, phenols and thiols.

In some embodiments, the one or more nanocarbon materials comprise one or more sheets, fibers, yarns, fabrics, mats, papers, and foams.

In some embodiments, the one or more polymers is derived from mixed aromatic feedstock.

In some embodiments, the mixed aromatic feedstock comprises a light aromatic stream, for example including aromatics from catalytic reforming or steam cracking (e.g., BT(E)X (mixtures of benzene, toluene, ethylbenzene, and xylene) and pyrolysis gasoline), reformate from catalytic reformers, and/or mixed alkylated naphthalenes.

In other embodiments, the mixed aromatic feedstock comprises one or more of residues of petrochemical refining or extraction, including vacuum residue, fluidic catalytic cracking (‘FCC’) bottoms (slurry oil, main column bottoms (MCB)), steam cracker tar, asphaltenes, C3-C7 rock, bitumen, K-pot bottoms, lube extracts, various streams from refinery processes and other synthetic aromatic hydrocarbons.

In some embodiments, the mixed aromatic feedstock has a H/C ratio less than 1.6, or less than 1.5, or less than 1.4, or less than 1.3, or less than 1.2, or less than 1.1, or less than 1.0, or less than 0.7.

In some embodiments, the mixed aromatic feedstock has an aromatic content of greater than about 50% by weight, or greater than about 60% by weight, or greater than about 70% by weight, or greater than about 80% by weight.

In some embodiments, the mixed aromatic feedstock comprises one or more transition metals.

In some embodiments, the weight average molecular weight of the one or more polymers is greater than about 10,000 Daltons, or greater than about 20,000 Daltons, or greater than about 50,000 Daltons, or greater than about 100,000 Daltons, or greater than about 200,000 Daltons, or greater than about 300,000 Daltons, or great than about 500,000 Daltons, or greater than about 700,000 Daltons, or greater than about 1,000,000 Daltons.

In another aspect, the present disclosure provides an article of manufacture comprising a polymer-nanocarbon composite according to any one of the herein disclosed embodiments.

In another aspect, the present disclosure provides a method of preparing a polymer-nanocarbon composite comprising the steps of:
(a) combining one or more nanocarbon materials with one or more polymerizable aromatic hydrocarbons and/or one or more polymerizable aromatic heterocyclics; and
(b) polymerizing the one or more polymerizable aromatic hydrocarbons and/or polymerizable aromatic heterocyclics.

In some embodiments, the method is conducted in the absence or substantial absence of additional solvent over and above the one or more polymerizable aromatic hydrocarbons and/or one or more polymerizable aromatic heterocyclics.

In some embodiments, the amount of additional solvent is less than about 10 wt. %, based on the total weight of components in step (a), or less than about 5 wt. %, or less than about 4 wt. %, or less than about 3 wt. %, or less than about 2 wt. %, or less than about 1 wt. %.

In some embodiments, the additional solvent is a non-aromatic solvent.

In some embodiments, the additional solvent is an aromatic solvent.

In some embodiments, additionally, or alternatively, the additional solvent is a non-polymerizable solvent. Additionally, or alternatively, the additional solvent is non-polymerizable under conditions in which the one or more polymerizable aromatic hydrocarbons and/or one or more polymerizable aromatic heterocyclics are polymerizable.

In some embodiments, the method further comprises the step of dispersing the one or more nanocarbon materials in the one or more polymerizable aromatic hydrocarbons and/or polymerizable aromatic heterocyclics, prior to polymerization.

In some embodiments, prior to combining one or more nanocarbon materials with one or more polymerizable aromatic hydrocarbons and/or one or more polymerizable aromatic heterocyclics, partial polymerization or oligomerization of the one or more polymerizable aromatic hydrocarbons and/or one or more polymerizable aromatic heterocyclics is performed.

In some embodiments, step (a) further comprises combining one or more linker agents with the one or more nanocarbon materials and one or more polymerizable aromatic hydrocarbons and/or polymerizable aromatic heterocyclics.

In some embodiments, the linker agent has the structure of Formula 1:

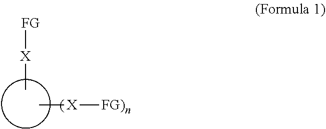

wherein the circle represents an aliphatic or aromatic moiety; FG (functional group) is, independently, alcohol, aldehyde, amine, amide, carboxylic acid, carboxylic anhydride, acid halide, alkene, alkyne, azide, arene, carbonate, ester, ether, halide, ketone, methylene, nitro, phenol, thiol, tosylate, mesylate, and sulfonate; each X, when present, is, independently, alkylene, cycloalkylene, or arylene bonded to a carbon atom of the aliphatic or aromatic moiety; n is an integer in the range of 1 to 5, or 1 to 10, or 1 to 15, or 1 to 20.

In another aspect, the present disclosure provides a carbon matrix-nanocarbon composite comprising the pyrolysis product of a polymer-nanocarbon composite according to any one of the herein disclosed embodiments.

In some embodiments, at least 50 wt. %, or at least 55 wt. %, or at least 60 wt. %, or at least 65 wt. %, of the elements present in the carbon matrix-nanocarbon composition is carbon.

In another aspect, the present disclosure provides an article of manufacture comprising a carbon matrix-nanocarbon composition according to any one of the herein disclosed embodiments.

In another aspect, the present disclosure provides a method of preparing a carbon matrix-nanocarbon composite, comprising:
(a) combining one or more nanocarbon materials with one or more polymerizable aromatic hydrocarbons and/or one or more polymerizable aromatic heterocyclics;
(b) polymerizing the one or more polymerizable aromatic hydrocarbons and/or polymerizable aromatic heterocyclics, thereby forming a polymer-nanocarbon composite; and
(c) pyrolyzing the polymer-nanocarbon composite.

In some embodiments, the polymer-nanocarbon composite is pyrolyzed at a temperature in the range of from 300 to 1000° C.

In some embodiments, following pyrolysis at a temperature in the range of from 300 to 1000° C., the product is subjected to further thermal treatment at a temperature greater than 1000° C.

In another aspect, there is provided a fiber-reinforced polymer composite (FRP), comprising: one or more polymers comprising aromatic hydrocarbon moieties and/or aromatic heterocyclic moieties, fibers, and one or more nanocarbon materials.

In some embodiments, the fibers are selected from the group consisting of glass, carbon, polymer, cellulosic and/or mineral fibers.

In some embodiments, the one or more nanocarbon materials are dispersed in the polymeric phase of the composite.

In some embodiments, the one or more nanocarbon materials are distributed throughout the polymeric phase of the composite.

In some embodiments, the one or more nanocarbon materials are physically or chemically immobilized/attached on the surface of fibers.

In another aspect, there is provided an article of manufacture comprising a fiber-reinforced polymer composite according to any one of the herein disclosed embodiments.

In another aspect there is provided a fiber-reinforced carbon matrix-nanocarbon composite comprising the pyrolysis product of a fiber-reinforced polymer composite according to any one of the herein disclosed embodiments.

In some embodiments, at least 50 wt. %, or at least 55 wt. %, or at least 60 wt. %, or at least 65 wt. %, of the elements present in the carbon matrix-nanocarbon composition is carbon.

In some embodiments, the fiber-reinforced carbon matrix-nanocarbon composite is a glass fiber-reinforced, carbon fiber-reinforced, or mineral fiber-reinforced carbon matrix-nanocarbon composite.

In another aspect there is provided an article of manufacture comprising a fiber-reinforced carbon matrix-nanocarbon composite according to any one of the herein disclosed embodiments.

In another aspect there is provided a method of preparing a fiber-reinforced polymer composite comprising the steps of:
(a) combining fibers, one or more nanocarbon materials, and one or more polymerizable monomers, wherein the polymerizable monomers are selected from the group consisting of a polymerizable aromatic hydrocarbon and a polymerizable aromatic heterocyclic; and
(b) polymerizing the one or more polymerizable monomers.

In some embodiments, the fibers are selected from the group consisting of glass, carbon, polymer, cellulosic and/or mineral fibers.

In some embodiments, the one or more nanocarbon materials are combined with the polymerizable monomer, prior to combining with the fibers.

In some embodiments, the one or more nanocarbon materials are dispersed in the one or more polymerizable monomers, prior to combining with the fibers.

In some embodiments, the one or more nanocarbon materials are distributed throughout the one or more polymerizable monomers, prior to combining with the fibers.

In some embodiments, the one or more nanocarbon materials are coated with the polymerizable monomer, prior to combining with the fibers.

In some embodiments, the one or more nanocarbon materials are physically or chemically immobilized/attached on the surface of fibers, prior to combining with the one or more polymerizable monomers.

In another aspect, there is provided a method of preparing a fiber-reinforced carbon matrix-nanocarbon composite comprising
(a) combining fibers, one or more nanocarbon materials, and one or more polymerizable monomers, wherein the polymerizable monomers are selected from the group consisting of a polymerizable aromatic hydrocarbon and a polymerizable aromatic heterocyclic;
(b) polymerizing the one or more polymerizable monomers, thereby forming a fiber-reinforced polymer-nanocarbon composite; and
(c) pyrolyzing the fiber-reinforced polymer-nanocarbon composite.

In some embodiments, the polymer-nanocarbon composite is pyrolyzed at a temperature in the range of from 300 to 1000° C.

In some embodiments, following pyrolysis at a temperature in the range of from 300 to 1000° C., the product is subjected to further thermal treatment at a temperature greater than 1000° C.

Further features and advantages of the present disclosure will be understood by reference to the following drawings and detailed description.

### BRIEF DESCRIPTION OF THE DRAWINGS

FIG. 1 is a flowsheet illustrating a method of preparing PNCCs with low filler contents (ca. 1%) by combining nanocarbon(s) with a polymer solution.

FIG. 2 is a flowsheet illustrating a method of preparing PNCCs with low filler contents (ca. 1%) by combining nanocarbon(s) with a solid polymer.

FIG. 3 is a flowsheet illustrating a method of preparing PNCCs with low filler contents (ca. 1%) by combining nanocarbon(s) with a polymer precursor solution.

FIG. 4 is a flowsheet illustrating a method of preparing PNCCs with high filler contents (>10%) by combining freestanding nanocarbon material with a polymer precursor solution.

FIG. 5 is a flowsheet illustrating a method of preparing PNCCs with low filler contents (ca. 1%) by combining nanocarbon(s) with aromatic hydrocarbon(s)/heterocycles(s), according to one embodiment of the present disclosure.

FIG. 6 is a flowsheet illustrating a method of preparing PNCCs with high filler contents (>10%) by combining freestanding nanocarbon materials with aromatic hydrocarbon(s)/heterocycles(s), according to one embodiment of the present disclosure.

FIG. 7 illustrates functionalization of carbon nanotubes via Diels-Alder reaction using electron deficient alkynes.

FIG. 8 illustrates functionalization of carbon nanotubes through diazonium salt generated from aromatic amines.

FIG. 9 illustrates functionalization of carbon nanotubes through reaction of aromatic amines with amyl nitrite.

### DETAILED DESCRIPTION OF THE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any compositions, methods and materials similar or equivalent to those described herein can also be used in the practice or testing of the present disclosure, the preferred compositions, methods and materials are now described.

It must also be noted that, as used in the specification and the appended claims, the singular forms ‘a’, ‘an’ and ‘the’ include plural referents unless otherwise specified. Thus, for example, reference to ‘aromatic hydrocarbon’ may include more than one aromatic hydrocarbon, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless specifically stated or obvious from context, as used herein, the term ‘about’ is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any methods provided herein can be combined with one or more of any of the other methods provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N.Y., 2001.

As used herein the term ‘nanocarbons’ refers to carbon allotropes with at least one nanoscale dimension, including single and multi-walled carbon nanotubes (CNTs), nanofibers, graphene, fullerenes, activated carbon, carbon black, carbon foams, other polymeric forms of carbon, and articles made therefrom.

As used herein, the term ‘mixed aromatic feedstock’ refers to a feedstock that comprises mixtures of different aromatic hydrocarbon molecules and/or mixtures of different aromatic heterocyclic molecules. Aromatic hydrocarbon molecules and/or aromatic heterocyclic molecules are constituents of one or more of residues of petrochemical refining or extraction, such as vacuum residue, fluidic catalytic cracking (‘FCC’) bottoms (slurry oil, main column bottoms (MCB)), steam cracker tar, asphaltenes, C3-C7 rock, bitumen, K-pot bottoms, lube extracts, or various other streams from refinery processes that have a high proportion of aromatics, for example >80% aromatics and other synthetic aromatic hydrocarbons. Mixed aromatic feedstock may also comprise a light aromatic stream including, for example, aromatics from catalytic reforming or steam cracking (e.g., BT(E)X and pyrolysis gasoline), reformate from catalytic reformers, or mixed alkylated naphthalenes. Mixed aromatic feedstock may also be derived from biological feedstocks, municipal solid waste, and waste plastic.

As used herein, the term ‘aromatic hydrocarbon’ refers to a hydrocarbon having at least one ring which is aromatic. Aromatic hydrocarbons fall within the class of arene molecules, and may comprise one or more aromatic rings with 4- or 5- or 6- or 7-, or 8 or more-membered carbon rings. They may be either alternant aromatic hydrocarbons (benzenoids), or non-alternant hydrocarbons, which may be either non-alternant conjugated or non-alternant non-conjugated hydrocarbons. Examples of aromatic hydrocarbon molecules include, but are not limited to, benzene, toluene, xylene, naphthalene, acenaphthene, acenaphthylene, anthanthrene, anthracene, azulene, benzo [a] anthracene, benzo [a] fluorine, benzo[c]phenanthrene, benzopyrene, benzo[a]pyrene, benzo[e]pyrene, benzo [b] fluoranthene, benzo[j]fluoranthene, benzo[k]fluoranthene, benzo[ghi]perylene, chrysene, corannulene, coronene, dicoronylene, diindenoperylene, fluorene, fluoranthene, fullerene, helicene, heptacene, hexacene, indene, kekulene, naphthalene, ovalene, pentacene, perylene, phenalene, phenanthrene, dihydrophenanthrene, picene, pyrene, tetracene, triphenylene, and their isomers, derivatives, alkylated derivatives, combinations, or condensed forms.

The aromatic hydrocarbons may also comprise molecules which contain the above disclosed aromatic hydrocarbons as fragments within larger molecules.

As used herein, the term ‘aromatic heterocyclic’ refers to a cyclic aromatic molecule that includes at least one heteroatom in an aromatic ring. Aromatic heterocyclic molecules can also be referred to as heteroaromatic molecules. Typical heteroatoms include oxygen, nitrogen, and sulfur. Examples of aromatic heterocyclic molecules include, but are not limited to, pyridine, furan, thiophene, acridine, benzimidazole, 2H-1-benzothine, benzthiazole, benzo [b] furan, benzo[b]thiophene, benzo[c]thiophene, carbazole, cinnoline, dibenzothiophene, iminodibenzyl, 1H-indazole, indole, indolizine, isoindole, isoquinoline, 1,5-naphthyridine, 1,8-naphthyridine, phenanthridine phenanthroline, phenazine, phenoxazine, phenothiazine, phthalazine, quinazoline, quinoline, 4H-quinolizine, thianthrene, and xanthene and their isomers, derivatives or combinations.

The aromatic heterocyclic molecules may also comprise molecules which contain the above disclosed aromatic heterocyclic molecules as fragments within larger molecules.

The aromatic hydrocarbon molecules and aromatic heterocyclic molecules may additionally comprise one or more functional groups comprising one or more of oxygen, nitrogen, or sulfur atoms, wherein said functional group is present as a substituent or within a substituent on an aromatic or aliphatic carbon atom.

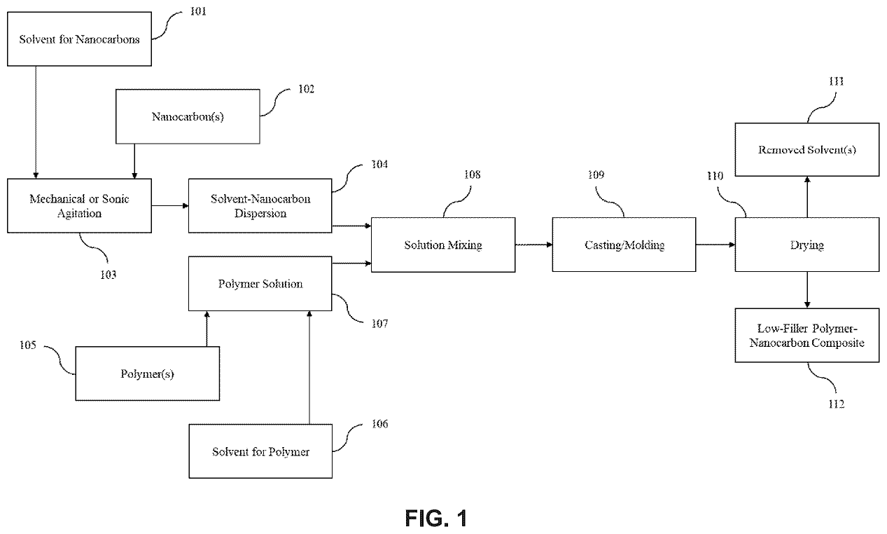

FIGS. 1 to 4 illustrate prior methods of preparing PNCCs.

FIG. 1 illustrates a method of preparing PNCCs with low filler contents (ca. 1%) by combining nanocarbon(s) with a polymer solution. Nanocarbon(s) 102 are combined with a suitable solvent 101 and the mixture mechanically and/or sonically agitated in vessel 103, to provide a liquid-nanocarbon dispersion 104. Polymer(s) 105 are combined with a suitable solvent 106 to provide polymer solution 107. The polymer solution 107 is combined with the liquid-nanocarbon dispersion 104 in vessel 108, and the resulting mixture cast or molded in step 109. The cast or molded mixture is then dried 110 and solvent removed 111 to afford a low filler polymer-nanocarbon composite 112.

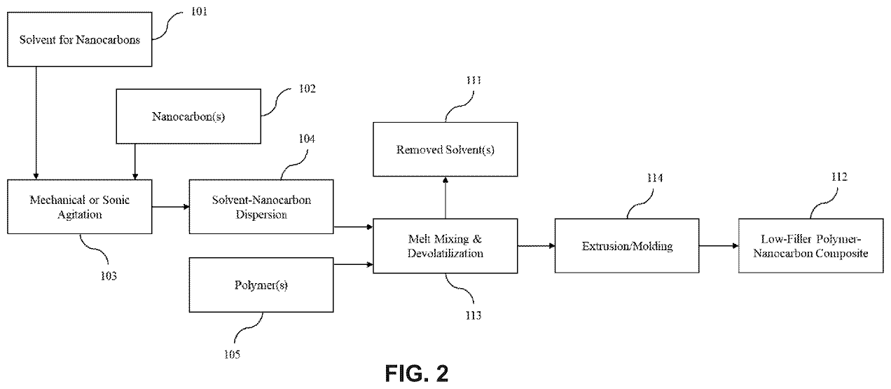

FIG. 2 illustrates a method of preparing PNCCs with low filler contents (ca. 1%) by combining nanocarbon(s) with a solid polymer. Nanocarbon(s) 102 are combined with a suitable solvent 101 and the mixture mechanically and/or sonically agitated in vessel 103, to provide a liquid-nanocarbon dispersion 104. Polymer(s) 105 are combined with the liquid-nanocarbon dispersion 104 and subjected to melt mixing and devolatization in unit 113. During this process solvent is removed 111 and the resulting polymer-nanocarbon mixture molded or extruded 114 to afford a low filler polymer-nanocarbon composite 112.

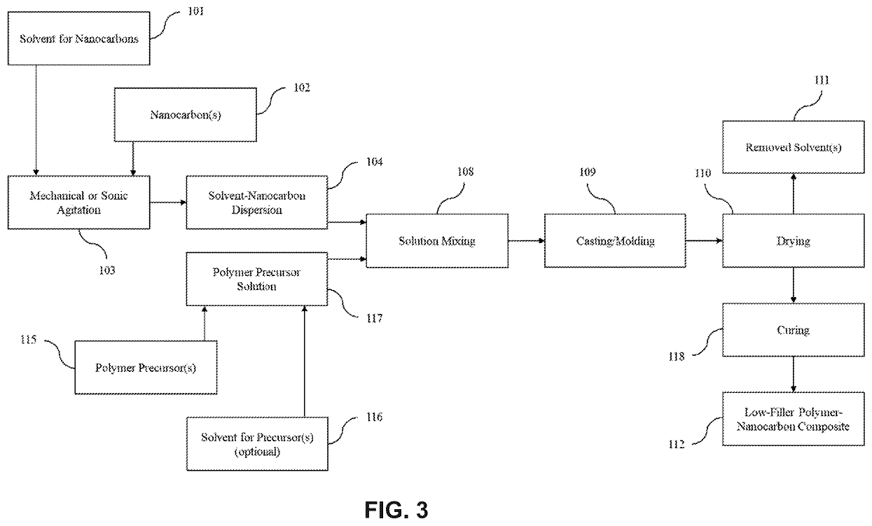

FIG. 3 illustrates a method of preparing PNCCs with low filler contents (ca. 1%) by combining nanocarbon(s) with a polymer precursor solution. Nanocarbon(s) 102 are combined with a suitable solvent 101 and the mixture mechanically and/or sonically agitated in vessel 103, to provide a liquid-nanocarbon dispersion 104. Polymer precursor(s) 115 are combined with a suitable solvent 116 to provide polymer precursor solution 117. The polymer precursor solution 117 is combined with the liquid-nanocarbon dispersion 104 in vessel 108, and the resulting mixture cast or molded in step 109. The cast or molded mixture is then dried 110 and solvent removed 111 and the resulting polymer precursor-nanocarbon dispersion cured 118 to afford a low filler polymer-nanocarbon composite 112. The use of solvent 116 is optional and in some cases the polymer precursor(s) 115 may be directly combined with the solvent-nanocarbon dispersion 104 in mixing step 108.

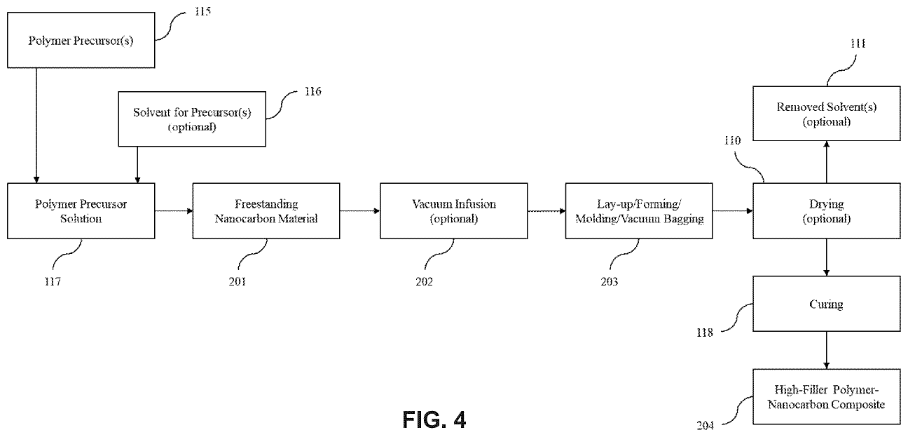

FIG. 4 illustrates a method of preparing PNCCs with high filler contents (>10%) by combining freestanding nanocarbon material with a polymer precursor solution. Polymer precursor 115 is optionally combined with solvent 116 to provide a polymer precursor solution 117. The polymer precursor 115 or polymer precursor solution 117 is then combined with freestanding nanocarbon material 201. The resulting mixture may then be subjected to optional vacuum infusion 202 and subsequently formed/molded in step 203. The formed/molded material is then optionally dried 110 and solvent removed 111. After optional drying the material is cured 118 to afford high-filler polymer-nanocarbon composite 204.

The present disclosure provides polymer-nanocarbon composites, said polymer-nanocarbon composites comprising one or more nanocarbon materials and one or more polymers, said polymers comprising aromatic hydrocarbon moieties and/or aromatic heterocyclic moieties.

The polymer-nanocarbon composites may be prepared by combining one or more nanocarbon materials with one or more polymerizable aromatic hydrocarbons and/or one or more polymerizable aromatic heterocyclics; and polymerizing the one or more polymerizable aromatic hydrocarbons and/or polymerizable aromatic heterocyclics.

The herein disclosed methods leverage the compatibility between aromatic hydrocarbon and/or aromatic heterocyclic liquids and nanocarbons to prepare polymer-nanocarbon composites. In embodiments, an aromatic hydrocarbon and/or aromatic heterocyclic liquid is selected which is (1) compatible with the nanocarbon of choice and (2) amenable to polymerization. In embodiments, the liquid may comprise a multicomponent mixture including, but not limited to, comonomers, initiators, inhibitors, catalysts, viscosity modifiers etc.

In embodiments, the aromatic hydrocarbon and/or aromatic heterocyclic liquid may be functionalized with one or more heteroatomic moieties, including, e.g., alcohols, aldehydes, amines, amides, acids, alkene, alkynes, azides, carbonates, esters, ethers, halides, ketones, nitro groups, olefins, phenols, sulfones, sulfonates, thiols, etc., to modulate compatibility and polymerizability.

In embodiments, the aromatic hydrocarbon and/or aromatic heterocyclic liquid may be used to prepare suspensions of would-be nanocarbon fillers or infiltrated into free-standing nanocarbon articles, e.g., yarns, fabrics, mats, papers, or foams.

The liquid mixture containing (or imbibed into) nanocarbon fillers, may be polymerized (cured) in place to high conversion, e.g., by heating, to form a polymeric matrix.

The resulting polymer-nanocarbon composite may maintain the superior, intimate, spacefilling contact between the filler and the newly formed polymer matrix. Polymer-nanocarbon composites prepared in this manner may provide an inexpensive, high-volume replacement for traditional fiber-reinforced polymer composites.

In embodiments, the herein disclosed methods may simplify and/or reduce the cost associated with polymer-nanocarbon composite fabrication by using polymerizable aromatic hydrocarbons and/or polymerizable aromatic heterocyclics as both dispersant or infiltrant and the polymer precursor. Compared with traditional solvent-aided methods, the herein disclosed methods may not require hazardous chemicals or additional process units associated with solvent removal and recovery.

Polymerizable aromatic hydrocarbons and/or polymerizable aromatic heterocyclics, are inexpensive and commercially available. The herein disclosed methods provide a route to upgrade such streams into valuable materials. Additionally, fabricating materials using the herein disclosed methods provides a low-CCh outlet for aromatic hydrocarbon or aromatic heterocycle utilization compared to combustion.

Polymer-nanocarbon composites manufactured using the herein disclosed methods may provide superior performance to those prepared via traditional solvent-aided techniques. The solvent removal process often leads to nanocarbon aggregation and/or void formation, both of which are detrimental to the performance of the polymer-nanocarbon composite. Polymerizing aromatic hydrocarbons and/or aromatic heterocycles in place may ameliorate these issues as the polymerizing matrix preserves the superior dispersion state of the filler from the suspension or infiltrated article and maintains intimate, space-filling contact with the nanocarbon material.

Moreover, aromatic hydrocarbon and/or aromatic heterocyclic liquids have comparable surface energies to nanocarbons, relatively low viscosities, and modest molecular volumes, making them well-suited for wicking into free-standing nanocarbon materials. This is in contrast with polymer solutions and liquid polymer precursors (which often contain oligomers, prepolymers, and other relatively high molecular weight components), which suffer from slow or incomplete infiltration.

Furthermore, covalent bonding between the polymeric matrix and the nanocarbon material may be promoted by incorporating, for example, dieneophiles (for Diels-Alder chemistry) or diazonium salts, which may form covalent bonds with nanocarbons, into the aromatic hydrocarbon and/or aromatic heterocyclic liquid. These covalent bonds are expected to substantially improve the stress transfer across the interface between the matrix and filler in load-bearing applications.

The herein disclosed methods afford straightforward manufacture of carbon-based nanocomposites by designing aromatic hydrocarbon and/or aromatic heterocyclic dispersants and infiltrants which may be directly polymerized in situ to preserve the dispersion state of the filler. The present disclosure provides a simple and effective method for producing high-quality PNCCs from aromatic hydrocarbon and/or aromatic heterocyclic liquids.

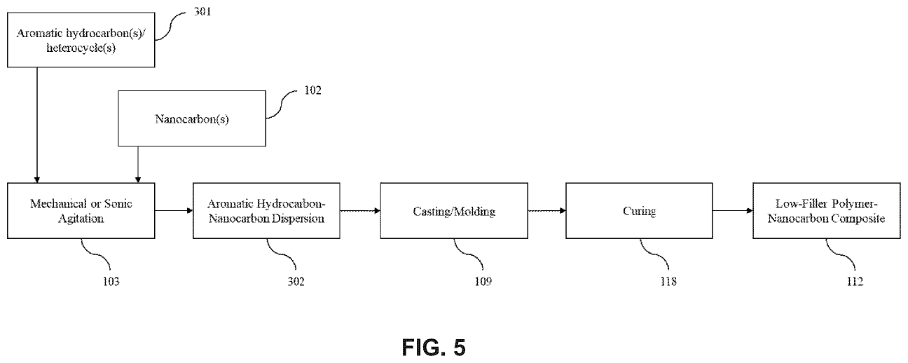

In an example, FIG. 5 illustrates a method of preparing PNCCs with low filler contents (ca. 1%) by combining nanocarbon(s) with aromatic hydrocarbon(s)/heterocycles(s), according to one embodiment of the present disclosure. Nanocarbon(s) 102 are combined with aromatic hydrocarbon(s)/heterocycle(s) 301 and the resulting mixture mechanically and/or sonically agitated 103 to afford aromatic hydrocarbon(s)/heterocycle(s)-nanocarbon dispersion 302. The dispersion is cast or molded in step 109 and then subsequently cured in step 118 to afford low-filler polymernanocarbon composite 112.

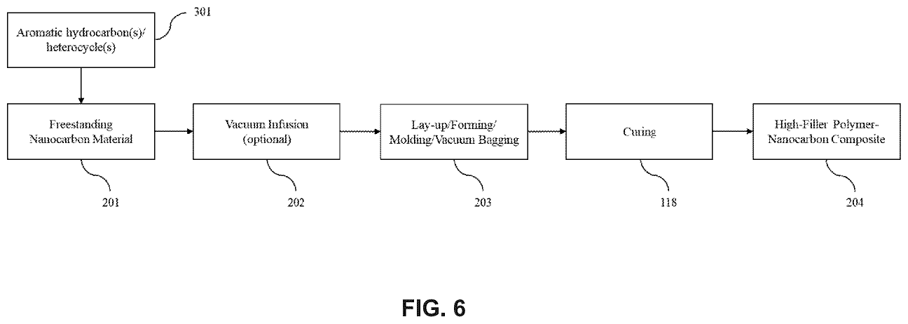

In another example, FIG. 6 illustrates a method of preparing PNCCs with high filler contents (>10%) by combining freestanding nanocarbon materials with aromatic hydrocarbon(s)/heterocycles(s), according to one embodiment of the present disclosure. Aromatic hydrocarbon(s)/heterocycle(s) 301 are added to freestanding nanocarbon material 201 and the resulting material optionally subjected to vacuum infusion 202. The material is then formed/molded in step 203. The formed/molded material is the cured 118 to afford high-filler polymer-nanocarbon composite 204.

The present disclosure also provides carbon matrix-nanocarbon composites, which can be produced by pyrolysis of the polymer-nanocarbon composites.

The present disclosure also provides fiber-reinforced polymer (FRP) composites, comprising: one or more polymers comprising aromatic hydrocarbon moieties and/or aromatic heterocyclic moieties, fibers, and one or more nanocarbon materials. Either or both of the fibers and the nanocarbon materials present in such materials may provide properties such as strength and/or reinforcement. Such materials find use in, for example, infrastructure applications.

The fiber-reinforced polymer (FRP) composites can be produced by (a) combining fibers, one or more nanocarbon materials, and one or more polymerizable monomers, wherein the polymerizable monomers are selected from the group consisting of a polymerizable aromatic hydrocarbon and a polymerizable aromatic heterocyclic; and (b) polymerizing the one or more polymerizable monomers.

The present disclosure also provides fiber-reinforced carbon matrix-nanocarbon composite, which can be produced by pyrolysis of the FRP composites.

### Aromatic Hydrocarbons/Heterocycles

Many aromatic hydrocarbon or aromatic heterocyclic liquids are suitable for use in the presently disclosed mixtures. Examples include one or more of monocyclic or polycyclic aromatic hydrocarbons and/or one or more of monocyclic or polycyclic aromatic heterocyclics. Mixtures of aromatic hydrocarbons and/or aromatic heterocyclics include light aromatic streams including, for example, aromatics from catalytic reforming or steam cracking (e.g., BT(E)X and pyrolysis gasoline), reformate from catalytic reformers, or mixed alkylated naphthalenes. Other streams enriched in polyaromatics and polyheterocyclics include vacuum residue, fluidic catalytic cracking (‘FCC’) bottoms, slurry oil, main column bottoms (MCB), steam cracker tar, asphaltenes, C3-C7 rock, bitumen, K-pot bottoms, lube extracts, and other synthetic aromatic hydrocarbons. These streams may be blended with lower molecular mass hydrocarbons to attain the desired properties, e.g., viscosity or cure kinetics. Traditionally, these streams are burned for their heating value, and are of low value to the refinery—upgrading these molecules by incorporating them into polymernanocarbon composites presents a high-value, low-CCh alternative.

### Mixed Aromatic Feedstock

Particularly suitable aromatic hydrocarbons and aromatic heterocyclics for forming the polymer-nanocarbon composites of the present disclosure may be obtained from various refinery process streams that otherwise have low intrinsic value. By forming a composite according to the disclosure herein, a considerably more valuable and useful material may be obtained. In illustrative embodiments, refinery process streams containing aromatic hydrocarbon and aromatic heterocyclic compounds suitable for use in the disclosure herein may include or derive from, for example, steam cracker tar, main column bottoms, vacuum residue, C5 rock, C3-C5 rock, slurry oil, asphaltenes, bitumen, K-pot bottoms, lube extracts, and any combination thereof. These terms will be familiar to one having ordinary skill in the art. Particular discussion regarding these refinery process streams is provided hereinafter.

Steam cracker tar (also referred to as steam cracked tar or pyrolysis fuel oil) may comprise a suitable source of aromatic hydrocarbons and aromatic heterocyclics in some embodiments of the present disclosure. “Steam cracker tar” is the high molecular weight material obtained following pyrolysis of a hydrocarbon feedstock into olefins, as described, for example, in U.S. Pat. No. 8,709,233, which is incorporated herein by reference. Suitable steam cracker tar may or may not have had asphaltenes removed therefrom. Steam cracker tar may be obtained from the first fractionator downstream from a steam cracker (pyrolysis furnace) as the bottoms product of the fractionator, nominally having a boiling point of 288° C. and higher. In particular embodiments, steam cracker tar may be obtained from a pyrolysis furnace producing a vapor phase including ethylene, propylene, and butenes; a liquid phase separated as an overhead phase in a primary fractionation step comprising C5+species including a naphtha fraction (e.g., C3-C10 species) and a steam cracked gas oil fraction (primarily C10-C15/C17 species having an initial boiling range of about 204° C. to 288° C.); and a bottoms fraction comprising steam cracker tar having a boiling point range above about 288° C. and comprising C15/C17+species.

Main column bottoms (also referred to as FCC main column bottoms or slurry oil) may comprise a suitable source of polyaromatic hydrocarbons in some embodiments of the present disclosure. Typical aromatic hydrocarbons and aromatic heterocycles that may be present in main column bottoms include those having molecular weights ranging from about 250 to about 1000. Three to eight fused aromatic rings may be present in some instances. Suitable main column bottoms may or may not have had asphaltenes removed therefrom. Residual cracking catalyst not removed cyclonically following cracking may or may not remain present in the main column bottoms. Both catalyst-containing and catalyst-free main column bottoms may be suitable for use in the present disclosure.

Vacuum residue may comprise a suitable source of aromatic hydrocarbons and aromatic heterocycles in some embodiments of the present disclosure. As the name suggests, “vacuum residue” is the residual material obtained from a distillation tower following vacuum distillation. Vacuum residue may have a nominal boiling point range of about 600° C. or higher.

C3 rock or C3-C5 rock may comprise a suitable source of aromatic hydrocarbons and aromatic heterocycles in some embodiments of the present disclosure. C3-C5 rock refers to asphaltenes that have been further treated with propane, butanes and pentanes in a deasphalting unit. Likewise, C3 rock refers to asphaltenes that have been further treated with propane. C3 and C3-C5 rock may be high in metals like Ni and V and may contain high amounts of N and S heteroatoms in heteroaromatic rings.

Bitumen or asphaltenes may comprise a suitable source of polyaromatic hydrocarbons in some embodiments of the present disclosure. Some sources consider bitumen and asphaltenes to be synonymous with one another. In general, asphaltenes refer to a solubility class of materials that precipitate or separate from an oil when in contact with paraffins (e.g., propane, butane, pentane, hexane, or heptane). Bitumen traditionally refers to a material obtained from oil sands and represents a full-range, higher-boiling material than raw petroleum.

### Polymerization

The polymerizability of aromatic hydrocarbons and/or aromatic heterocycles may be enhanced by the presence and/or introduction of functional groups. Alternatively, or additionally, one or more linking agents may be utilized, for example, formaldehyde, divinyl benzene, benzene dimethanol, dichlorodimethyl benzene or equivalently functionalized polynuclear aromatics. Catalysts, promoters, inhibitors, etc. may also be incorporated to modulate the rate of the polymerization reaction. The liquid mixture can then be combined with nanocarbons to prepare suspensions, gels, pastes, doughs, or impregnated articles. The suspensions may be optionally prepared with the aid of mechanical action, e.g., sonication or high-speed mixing. Dispersion and infiltration may also be performed at elevated temperatures to modulate the liquid viscosity. Dispersion and infiltration may also be performed under vacuum to remove gaseous solutes and/or to provide driving force for imbibition.

The resulting material can then be processed, shaped, and molded into the desired form. Finally, the aromatic liquid is polymerized (cured) in place such that the morphology of the nanocarbons is preserved throughout the process. Possible curing chemistries include phenolformaldehyde condensation, Friedel-Crafts reaction, radical polymerization, click reactions, cycloaddition reaction, aldol reaction, esterification, amidization, ring-opening, or ionic polymerization.

Polymerization may be carried out over a wide range of temperatures and is carried out at a temperature sufficient to effect reaction. The temperature is preferably between about 25° C. to about 300° C., or between about 25° C. to about 250° C., or between about 70° C. to about 200° C., or between about 70° C. and 150° C. Preferably, the reaction temperature is above 25° C., or above 50° C., or above 60° C., or above 70° C., or above 80° C. In some embodiments the polymerization may be performed at ambient temperature. The polymerization may be carried out at a single temperature or, sequentially, at different temperatures.

The application of heat may be via extrinsic heating such as in an autoclave or intrinsic Joule heating of the nanocarbon phase. Polymerization may occur under electromagnetic radiation, such as ultraviolet light. In some embodiments, partial curing may be performed to obtain laminates that may be arranged to obtain bulk nanocomposite structures.

Polymerization may be performed at ambient pressure or at elevated pressure. In embodiments the pressure may be greater than about 1 bar, or greater than about 2 bar, or greater than about 3 bar, or greater than about 4 bar. In other embodiments the pressure may be between about 1 bar and about 8 bar, or between about 2 bar and about 6 bar.

Reaction time may vary and is dependent on the reaction temperature, ratio of reactants and pressure. The reaction will preferably be carried out over a period of about 1 to about 10 hours, more preferably over a period of about 3 to about 24 hours, and most preferably over a period of about 4 to about 16 hours.

The extent of reaction may be monitored by, for example, solid-state nuclear magnetic resonance (NMR) spectroscopy or Fourier transform infrared spectroscopy (FTIR).

In embodiments, a key feature of the presently disclosed polymerization method is that it is conducted in the absence or substantial absence of additional non-polymerizable solvent over and above the one or more polymerizable aromatic hydrocarbons and/or one or more polymerizable aromatic heterocyclics.

In embodiments, the amount of additional non-polymerizable solvent is less than about 10 wt. %, based on the total weight of components in step (a), or less than about 5 wt. %, or less than about 4 wt. %, or less than about 3 wt. %, or less than about 2 wt. %, or less than about 1 wt. %.

The absence or substantial absence of additional non-polymerizable solvent results in the minimization of voids in the polymer-nanocarbon composite and also reduces the requirement for solvent to be removed.

### Nanocarbons

The similarity between the aromatic structures in the liquid and nanocarbon may promote intimate physical contact between the polymer matrix and the nanocarbon material. In some embodiments specific functionalities may be incorporated in the polymer and/or nanocarbon to promote covalent crosslinking between the polymer and the nanocarbon, further improving the mechanical properties of the composite.

Several approaches have been developed for the covalent modification of nanocarbons. Often these require reactive defects in the nanocarbon structure, which can be inherent or generated by pretreatment under strong acidic or oxidative conditions, such as sonication in a mixture of concentrated nitric and sulfuric acid, or heating in a mixture of sulfuric acid and hydrogen peroxide. In the case of carbon nanotubes, this treatment results in the formation of short opened tubes with oxygenated functions (carbonyl, carboxyl, hydroxyl, etc.), which can be detrimental to the mechanical, electronic, or thermal properties of the eventual nanocomposite.

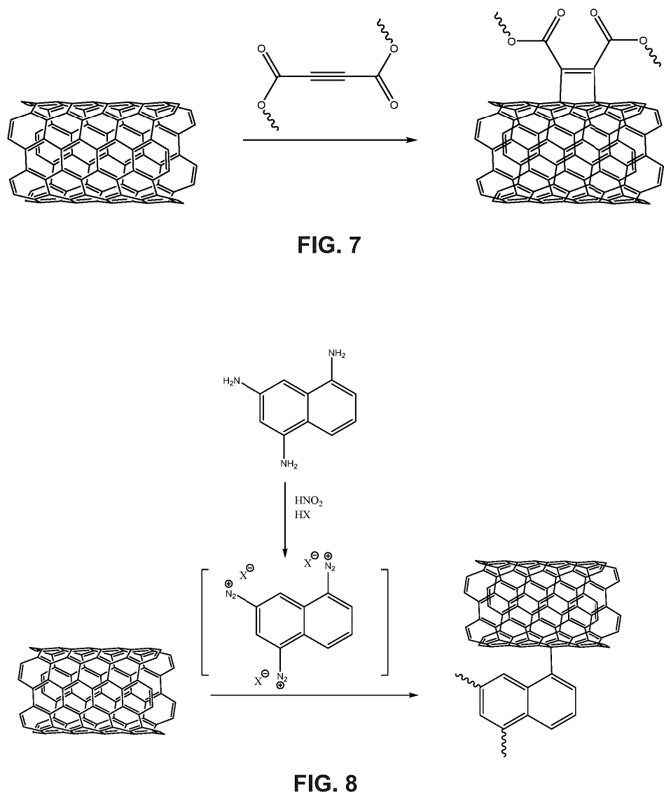

Cycloaddition at the sidewall of carbon nanotubes via Diels-Alder reaction is an alternative to acidic oxidation because of its balance between the fidelity of the functionalization reaction and the preservation of intrinsic properties of the carbon nanotubes. The Diels Alder reactionbased surface modification (see FIG. 7) is a facile method which can be performed in various types of solvents, including the aromatic streams described above, and does not require surface pretreatment or catalysts. Diazonium salt chemistry may also be utilized to functionalize carbon nanotubes in a very efficient manner (see FIG. 8). Formation of diazonium salts in situ from aromatic amine may mitigate the hazards associated with the direct use and long-term storage of diazonium compounds. Either the Diels-Alder or diazonium salt routes can be incorporated into the methods described herein to promote the formation of covalent bonding between the polymer matrix and the nanocarbons via the appropriately functionalized dieneophile or amide. Polytriazoles, polyamides, polyimides and polyesters, are particularly amenable to this approach. This strategy admits the formation of thermosetting or thermoplastic matrices which are covalently bound to the nanocarbon filler. These covalent bonds are expected to improve the stress transfer across the interface in load-bearing applications.

### Fibers

Any suitable fibers can be incorporated in the fiber-reinforced polymer (FRP) composites or fiber-reinforced carbon matrix-nanocarbon composites. Examples of suitable fibers include glass fibers, carbon fibers, polymer fibers, cellulosic fibers and/or mineral fibers. The appropriate fiber can be selected based on the intended end use.

Typically, fibers have a diameter in the range of from 1 to 50 μm. In some embodiments, the fibers have a diameter in the range of from 3 to 20 μm.

The fibers may be of any desired length. In some embodiments, the fibers may be continuous. In some embodiments, the fibers may be portions which have been chopped, or cut from a longer length. In some embodiments, the fibers have an average length of at least 1 mm, or at least 2 mm, or at least 3 mm, or at least 5 mm, or at least 10 mm, or at least 20 mm.

In some embodiments, the fibers used have been spun to produce larger threads, e.g. fiber threads having larger diameter.

Examples of carbon fibers include those having high strength as well as those having lower strength, carbon fibers having high modulus, as well as those having lower modulus, carbon fiber produced from polyacrylonitrile (PAN), rayon or pitch.

Examples of polymeric fibers include aramids (e.g. poly(/?-phenyleneterephthalamide) (PPTA, Kevlar®), or poly(m-phenylene isophthalamide) (MPIA, Nomex®)), polyamides (e.g. Nylons®), arylates (e.g. Vectran®), polyesters (e.g. poly(ethylene terephthalate)), polybenzoxazole (PBO), polybenzthiazole (PBZT), polybenzimidazole, poly(hydroquinone-diimidazopyridine) (PIPID or M5®), polyethylene (e.g. ultrahigh molecular weight polyethylene (UHMWPE)), acrylic fiber, and phenolic fiber.

Examples of cellulosic fibers include cellulose microfibers, cellulose nanofibers, and cellulose nanofibrils.

Examples of mineral fibers include basalt and mineral wool, for example alkaline earth silicate wool, alumina silicate wool, polycrystalline wool, and kaowool.

The amount of fiber included in the composites can also be tailored depending on the desired application. In some embodiments, the fiber volume fraction of the composite is in the range of from 10% to 65%. In some embodiments, the fiber volume fraction of the composite is in the range of from 40 to 65%. In some embodiments, the fiber volume fraction of the composite is in the range of from 10 to 20%, or from 20 to 30%, or from 30 to 40%, or from 40 to 45%, or from 45 to 50%, or from 50 to 55%, or from 55 to 60%, or from 60 to 65%. In the case of structural composites, for example, fiber volume content is typically in the range of from 40 to 65%.

The fibers can for example be combined with the nanocarbon material and a polymerizable material (e.g. a monomer or oligomer), which can undergo polymerization to produce the FCP composites. Any suitable method for combining the components and producing the composite may be utilized.

In some embodiments, the one or more nanocarbon materials are combined with the polymerizable material (e.g. monomer) prior to combining with the fibers, for example the nanocarbon materials may be dispersed in or distributed throughout the polymerizable phase prior to combining with the fibers.

In some embodiments, the one or more nanocarbon materials are combined with a compatible solvent, for example forming a dispersal of the nanocarbon material in the compatible solvent, prior to combining with the polymerizable material and the fibers.

In some embodiments, the compatible solvent can act as a matrix precursie in the production of composites including fibers having nanocarbon materials immobilized/attached to their surface.

In some embodiments, the one or more nanocarbon materials are physically or chemically immobilized/attached on the surface of the fibers. Various approaches may be used to immobilize/attach the nanocarbon materials with/to the fibers.

For example, chemical vapor deposition of nanocarbons on fibers may be utilized. Typically, a catalyst precursor is deposited on the fiber surface. A hydrocarbon feed may be contacted with the fiber surface at high temperature which supplies carbon to the catalyst, and which is converted to nanocarbon (see for example Li et al, Composites Science and Technology, 2015, 117, 139-145).

As another example, electrophoretic deposition may be utilized. The fibers can form an electrode in an electrolytic bath with suspended nanocarbons. The nanocarbons may be charged, with polarity on the fibers drawing the nanocarbons to collect on the fiber surface (see for example An et al, Carbon, 2012, 50 (11), 4130-4143).

As a further example, dip coating techniques may be used. For example fibers may be dipped in a nanocarbon suspension and dried to immobilize the nanocarbons (see for example Jamnani et al, Journal of Nanomaterials, 2015, Article ID 149736, https://doi. org/10.1155/2015/149736

In some embodiments, the one or more nanocarbon materials are coated with polymerizable material (e.g. monomer, oligomer) prior to combining with the fibers. Coating of the nanocarbon material with the polymerizable material is carried out, for example, to improve compatibilization during subsequent composite processing. For example, in one embodiment, the nanocarbon material may be coated with polymerizable material, followed by combining with fibers, and then followed by combining with further polymerizable material to produce the composite. Typically, when a coating step is employed, a thin coating layer is formed on the nanocarbon material, for example a layer having a thickness in the range of from 2 to 500 nm, or from 5 to 400 nm, or from 10 to 300 nm, or from 25 to 200 nm.

In some embodiments, where the one or more nanocarbon materials are physically or chemically immobilized/attached on the surface of the fibers, these materials may for example be mixed with a compatible solvent, to provide a matrix precursor. The matrix precursor can then be combined with a polymerizable material (e.g. monomer or oligomer) and subjected to polymerization conditions to produce a composite.

### Carbon Matrix-Nanocarbon Composites

The polymer-nanocarbon composites and fiber-reinforced polymer (FRP) composites of the present disclosure may be subjected to further treatment, for example they may be subjected to pyrolysis to produce carbon matrix-nanocarbon composites and fiber-reinforced carbon matrix-nanocarbon composites respectively. The present disclosure also encompasses such composites, their production, and their uses.

Typically, during pyrolysis, the polymer-nanocarbon composites or FRP composites are heated to a temperature in the range of from about 300 to about 1000° C. This results in loss of a significant proportion of elements such as oxygen, nitrogen, sulfur and hydrogen which may be present in the polymer-nanocarbon or FRP composite. The resulting product contains mostly amorphous carbon. This material can then be subjected to further thermal treatment at high temperature, e.g. at a temperature above 1000° C. to convert a significant proportion of the amorphous carbon to graphitic carbon.

Pyrolysis and/or further thermal treatment steps are typically carried out under an inert atmosphere.

In some embodiments, the material is subjected to thermal treatment at a temperature above 2000° C. Such temperatures may be used, for example, where increased pressure conditions and/or a catalyst is not used in the thermal treatment step.

In some other embodiments, for example where a catalyst and/or increased pressure conditions are used, the thermal treatment step is carried out at a lower temperature, e.g. still above 1000° C. but less than 2000° C.

In the case of fiber-reinforced carbon matrix-nanotube composites, the compotes may for example be glass-carbon, carbon-carbon, or mineral-carbon composites, depending on the nature of the fibers used.

Following pyrolysis of the polymer component, the resulting material (referred to herein as carbon matrix-nanocarbon composites and fiber-reinforced carbon matrix-nanocarbon composites) has a carbon-rich phase, for example a phase in which at least 50 wt. % of the atoms present are carbon atoms.

The term carbon matrix refers to the phase of the composite which is derived from the polymer component of the polymer-nanocarbon or FRP composite, and which has undergone loss of heteroatoms and hydrogen upon pyrolysis.

In some embodiments, where a carbon matrix-nanocarbon composite is produced, at least 50 wt. %, or at least 55 wt. %, or at least 60 wt. %, or at least 65 wt. %, of the atoms present in the carbon matrix are carbon atoms.

In some embodiments, where a carbon matrix-nanocarbon composite is produced, at least 50 wt. %, or at least 55 wt. %, or at least 60 wt. %, or at least 65 wt. %, of the atoms present in the carbon matrix-nanocarbon composition are carbon atoms.

In some embodiments, where a fiber-reinforced carbon matrix-nanocarbon composite is produced, at least 50 wt. %, or at least 55 wt. %, or at least 60 wt. %, or at least 65 wt. %, of the atoms present in the carbon matrix are carbon atoms.

In some embodiments, where a fiber-reinforced carbon matrix-nanocarbon composite is produced, at least 50 wt. %, or at least 55 wt. %, or at least 60 wt. %, or at least 65 wt. %, of the atoms present in the fiber-reinforced carbon matrix-nanocarbon composition are carbon atoms.

The present disclosure also encompasses articles of manufacture incorporating the carbon matrix-nanocomposites and fiber-reinforced carbon matrix-nanocomposites.

### EXAMPLES

### Example 1—Polymer-Nanocarbon Composite Derived from Functionalized Alkylated Naphthalenes and Carbon Nanotube Powder

To a reaction vessel was added 50 g of Aromatic 200 (mixed alkylated naphthalene) and 0.25 g carbon nanotubes in powder form. The nanotubes were dispersed via sonication. 1,4-benzenedimethanol 50 g (1:1 wt. ratio to Aromatic 200) and 1 g (1 wt. %) 2-naphthalenesulfonic acid catalyst were then added and the mixture heated to 120° C. under continuous mechanical stirring. When the viscosity of the mixture reached a honey-like viscosity the reaction mixture was transferred into a mold and then placed in an autoclave and pressurized to 4 bar and slowly heated to 130° C. and held at that temperature for 10 hours. The pressure was then released and the mixture cooled to room temperature. The solid material was then removed from the mold and cured further by placing in a 150° C. oven at atmospheric pressure for 5 hours.

### Example 2—Polymer-Nanocarbon Composite Derived from Functionalized Alkylated Naphthalenes and Carbon Nanotube Sheet

To a reaction vessel was added 50 g of Aromatic 200, 50 g (1:1 wt. ratio) of 1,4-benzenedimethanol, and 1 g (1 wt. %) 2-naphthalenesulfonic acid catalyst and the mixture heated to 120° C. with stirring. When the viscosity reached a honey-like viscosity the reaction mixture was transferred into a molding bag pre-laid with a carbon nanotube (CNT) sheet and then a vacuum pump was connected to the mold bag to aid in the infiltration of the CNT sheet and remove excess resin. The molding bag was placed in an autoclave and pressurized to 4 bar and slowly heated to 130° C. and held at that temperature for 10 hours. The pressure was then released and the mixture cooled to room temperature. The solid material was then removed from the mold and cured further by placing in a 150° C. oven at atmospheric pressure for 5 hours.

### Example 3—Polymer-Nanocarbon Composite Derived from Aromatic Medium and Functionalized Carbon Nanotubes

Diels-Alder reaction between nanotubes and dienes: small molecules or oligomers or polymers carrying electron deficient reactive dienes, such as diethyl acetylenedicarboxylate (˜1 mol equiv.) or acetylenedicarboxylic acid (˜1 mol equiv.), is mixed with carbon nanotubes (˜0.1 mol equiv, but ratios may vary) in a reaction vessel and the reaction mixture was stirred for 24 h (alternative reaction times are contemplated) at 110° C. (can be performed at various temperatures ranging from ambient temperature to above). The reaction mixture is concentrated and then placed in an autoclave to remove the residual of the volatiles. The dry material can be dispersed in an aromatic medium which is subsequently cured, according to the procedure of Example 1. Alternatively, the dry material can be used to prepare a free-standing nanocarbon object, e.g., fiber or paper, and infiltrated with an aromatic liquid, which is subsequently cured, according to the procedure of Example 2.

### Example 4—Polymer-Nanocarbon Composite Derived from Aromatic Medium and Functionalized Carbon Nanotubes

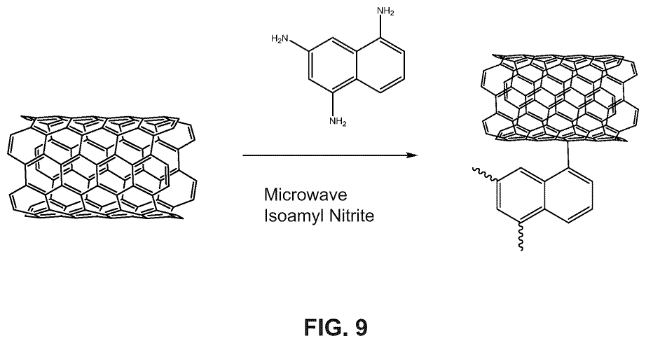

Carbon nanotubes (10 mg) were sonicated in deionized water together with (520 mg, 3.3 mmol) naphthalene-1,5-diamine for 10 min in a microwave glass vessel. Isoamyl nitrite (0.22 mb, 1.6 mmol) was added, and a condenser was placed on the vessel. The mixture was irradiated for 60 min at 80° C. After being cooled to room temperature, the crude product was filtered on a Millipore membrane (PTFE, 0.2 pm). The product was removed from the filter and washed with methanol and acetone (sonicated and filtered) until the filtrate was clear and finally washed with 40 mb of CH2CI2 to yield functionalized nanotubes (see scheme in FIG. 9). The product can be dispersed in an aromatic medium which is subsequently cured, according to the procedure of Example 1. Alternatively, the product can be used to prepare a free-standing nanocarbon object, e.g., fiber or paper, and infiltrated with an aromatic liquid, which is subsequently cured, according to the procedure of Example 2.

### Example 5—Nanocarbon Reinforced Polymer Matrix and Fiber Composite Derived from Functionalized Alkylated Naphthalenes, Carbon Nanotube Powder and Carbon Fiber

To a reaction vessel was added 50 g of Aromatic 200 (mixed alkylated naphthalene) and 0.25 g carbon nanotubes in powder form. The nanotubes were dispersed via sonication. 1,4-benzenedimethanol 50 g (1:1 wt. ratio to Aromatic 200) and 1 g (1 wt. %) 2-naphthalenesulfonic acid catalyst were then added and the mixture heated to 120° C. under continuous mechanical stirring. When the viscosity of the mixture reached a honey-like viscosity the reaction mixture was transferred into a molding bag pre-laid with a carbon fiber fabric and then a vacuum pump was connected to the mold bag to aid in the infiltration of the fabric and remove excess resin. The molding bag was placed in an autoclave and pressurized to 4 bar and slowly heated to 130° C. and held at that temperature for 10 hours. The pressure was then released and the material was cooled to room temperature. The solid material was then removed from the mold and cured further by placing in a 150° C. oven at atmospheric pressure for 5 hours.

### Example 6—Immobilized Nanocarbon-Reinforced Polymer Matrix and Fiber Composite Derived from Functionalized Alkylated Naphthalenes, Carbon Nanotube Powder and Carbon Fiber

3 g of carbon nanotubes were added to 100 ml of m-cresol and sonicated to disperse. A unidirectional tow of carbon fibers was immersed in the suspension for 1 hr. The fibers were then slowly (0.5 mm/sec) extracted from the suspension and dried at 250° C. to leave a layer of carbon nanotubes immobilized on the surface. To a reaction vessel was added 50 g of Aromatic 200, 50 g (1:1 wt. ratio) of 1,4-benzenedimethanol, and 1 g (1 wt. %) 2-naphthalenesulfonic acid catalyst and the mixture heated to 120° C. with stirring. When the viscosity of the mixture reached a honey-like viscosity the reaction mixture was transferred into a molding bag pre-laid with the nanotube coated carbon fiber fabric and then a vacuum pump was connected to the mold bag to aid in the infiltration of the fabric and remove excess resin. The molding bag was placed in an autoclave and pressurized to 4 bar and slowly heated to 130° C. and held at that temperature for 10 hours. The pressure was then released and the material was cooled to room temperature. The solid material was then removed from the mold and cured further by placing in a 150° C. oven at atmospheric pressure for 5 hours.

### Example 7—Carbon Matrix-Nanocarbon Composite Derived from Functionalized Alkylated Naphthalenes and Carbon Nanotube Powder

To a reaction vessel was added 50 g of Aromatic 200 (mixed alkylated naphthalene) and 0.25 g carbon nanotubes in powder form. The nanotubes were dispersed via sonication. 1,4-benzenedimethanol 50 g (1:1 wt. ratio to Aromatic 200) and 1 g (1 wt. %) 2-naphthalenesulfonic acid catalyst were then added and the mixture heated to 120° C. under continuous mechanical stirring. When the viscosity of the mixture reached a honey-like viscosity the reaction mixture was transferred into a mold and then placed in an autoclave and pressurized to 4 bar and slowly heated to 130° C. and held at that temperature for 10 hours. The pressure was then released and the material was cooled to room temperature. The solid material was then removed from the mold and cured further by placing in a 150° C. oven at atmospheric pressure for 5 hours. The cured material was then heated in an inert atmosphere to a temperature of 800° C. to pyrolyze the cured polymer matrix.

### Example 8—Carbon Matrix-Nanocarbon Composite Derived from Functionalized Alkylated Naphthalenes and Carbon Nanotube Sheet

To a reaction vessel was added 50 g of Aromatic 200, 50 g (1:1 wt. ratio) of 1,4-benzenedimethanol, and 1 g (1 wt. %) 2-naphthalenesulfonic acid catalyst and the mixture heated to 120° C. with stirring. When the viscosity reached a honey-like viscosity the reaction mixture was transferred into a molding bag pre-laid with a carbon nanotube (CNT) sheet and then a vacuum pump was connected to the mold bag to aid in the infiltration of the CNT sheet and remove excess resin. The molding bag was placed in an autoclave and pressurized to 4 bar and slowly heated to 130° C. and held at that temperature for 10 hours. The pressure was then released and the mixture cooled to room temperature. The solid material was then removed from the mold and cured further by placing in a 150° C. oven at atmospheric pressure for 5 hours. The cured material was then heated in an inert atmosphere to a temperature of 800° C. to pyrolyze the cured polymer matrix.

### Example 9-Nanocarbon Reinforced Carbon Matrix Composite Derived from Functionalized Alkylated Naphthalenes and Carbon Nanotube Powder

To a reaction vessel was added 50 g of Aromatic 200 (mixed alkylated naphthalene) and 0.25 g carbon nanotubes in powder form. The nanotubes were dispersed via sonication. 1,4-benzenedimethanol 50 g (1:1 wt. ratio to Aromatic 200) and 1 g (1 wt. %) 2-naphthalenesulfonic acid catalyst were then added and the mixture heated to 120° C. under continuous mechanical stirring. When the viscosity of the mixture reached a honey-like viscosity the reaction mixture was transferred into a molding bag pre-laid with a carbon fiber fabric and then a vacuum pump was connected to the mold bag to aid in the infiltration of the fabric and remove excess resin. The molding bag was placed in an autoclave and pressurized to 4 bar and slowly heated to 130° C. and held at that temperature for 10 hours. The pressure was then released and the mixture cooled to room temperature. The solid material was then removed from the mold and cured further by placing in a 150° C. oven at atmospheric pressure for 5 hours. The cured material is then heated in an inert atmosphere to a temperature of 800° C. to pyrolyze the cured polymer matrix.

### Certain Embodiments

Certain embodiments of composites and methods according to the present disclosure are presented in the following paragraphs.

Embodiment 1 provides a polymer-nanocarbon composite, said polymer-nanocarbon composite comprising one or more nanocarbon materials and one or more polymers, said polymers comprising aromatic hydrocarbon moieties and/or aromatic heterocyclic moieties.

Embodiment 2 provides a polymer-nanocarbon composite according to embodiment 1, wherein the one or more nanocarbon materials comprise one or more of carbon nanotubes, carbon nanofibers, graphene, fullerenes, activated carbon, carbon black, carbon foams, and articles made therefrom.

Embodiment 3 provides a polymer-nanocarbon composite according to embodiment 1 or embodiment 2, wherein the one or more nanocarbon materials are dispersed within or distributed throughout the polymer-nanocarbon composite.

Embodiment 4 provides a polymer-nanocarbon composite according to any one of embodiments 1 to 3, wherein the one or more nanocarbon materials are distributed throughout the polymer-nanocarbon composite.

Embodiment 5 provides a polymer-nanocarbon composite according to any one of embodiments 1 to 4, wherein the amount of the one or more nanocarbon materials is up to about 70 vol. %, based on the total volume of the polymer-nanocarbon composite.

Embodiment 6 provides a polymer-nanocarbon composite according to any one of embodiments 1 to 5, wherein the one or more nanocarbon materials have at least one dimension in a size ranging from about 0.2 nm to about 100 nm.

Embodiment 7 provides a polymer-nanocarbon composite according to any one of embodiments 1 to 6, wherein the polymer-nanocarbon composite has a void fraction of less than about 5 vol. %, or less than about 4 vol. %, or less than about 2 vol. %, or less than about 1 vol. %, or less than about 0.5 vol. %, or less than about 0.1 vol. %, based on the total volume of the polymer-nanocarbon composite, for example as measured by ASTM D3172 Method I.

Embodiment 8 provides a polymer-nanocarbon composite according to any one of embodiments 1 to 7, wherein the amount of volatiles in the polymer-nanocarbon composite is less than about 10 wt. %, or less than about 5 wt. %, or less than about 2 wt. %, or less than about 1 wt. %, or less than about 0.5% wt. %, or less than about 0.2 wt. %.

Embodiment 9 provides a polymer-nanocarbon composite according to any one of embodiments 1 to 8, wherein the amount of extractables in the polymer-nanocomposite is less than about 10 wt. %, or less than about 5 wt. %, or less than about 2 wt. %, or less than about 1 wt. %, or less than about 0.5% wt. %, or less than about 0.2 wt. %.

Embodiment 10 provides a polymer-nanocarbon composite according to any one of embodiments 1 to 9, wherein the composite is derived from a composition comprising one or more nanocarbon materials and one or more aromatic hydrocarbons and/or aromatic heterocyclics, wherein said composition comprises less than about 10 wt. % solvent, or less than about 5 wt. %, or less than about 4 wt. %, or less than about 3 wt. %, or less than about 2 wt. %, or less than about 1 wt. %, based on the total weight of nanocarbon materials, one or more aromatic hydrocarbons and/or aromatic heterocyclics, and solvent.

Embodiment 11 provides a polymer-nanocarbon composite according to any one of embodiments 1 to 10, wherein the aromatic hydrocarbon moieties and aromatic heterocyclic moieties comprise one or more monocyclic aromatic moieties, one or more polycyclic aromatic moieties and mixtures thereof.

Embodiment 12 provides a polymer-nanocarbon composite according to any one of embodiments 1 to 11, wherein the one or more polymers comprise a plurality of different monocyclic aromatic moieties and/or polycyclic aromatic moieties.

Embodiment 13 provides a polymer-nanocarbon composite according to any one of embodiments 1 to 12, wherein the average molecular weight of aromatic hydrocarbon moieties and/or aromatic heterocyclic moieties is between about 50 Daltons and about 1200 Daltons, or between about 150 and about 1200 Daltons, or between about 300 and about 1200 Daltons, or between about 400 and about 1200 Daltons, or between about 600 and about 900 Daltons, or between about 650 and about 850 Daltons, or between about 50 and 300 Daltons.

Embodiment 14 provides a polymer-nanocarbon composite according to any one of embodiments 1 to 13, wherein the one or more aromatic hydrocarbon moieties and/or aromatic heterocyclic moieties are linked via aryl-aryl bonds, aryl-heteroaryl bonds, heteroaryl-heteroaryl bonds and combinations thereof.

Embodiment 15 provides a polymer-nanocarbon composite according to any one of embodiments 1 to 14, wherein the one or more aromatic hydrocarbon moieties and/or aromatic heterocyclic moieties are linked via one or more linking groups.

Embodiment 16 provides a polymer-nanocarbon composite according to embodiment 15, wherein the one or more linking groups comprise one or more methylene groups, and/or wherein the one or more linking groups comprise at least one aromatic ring.

Embodiment 17 provides a polymer-nanocarbon composite according to embodiment 15 or embodiment 16, wherein the one or more linking groups comprise one or more heteroatoms.

Embodiment 18 provides a polymer-nanocarbon composite according to any one of embodiments 1 to 17, wherein the one or more aromatic heterocyclic moieties comprise one or more ring atoms selected from the group consisting of nitrogen, sulfur, and oxygen.

Embodiment 19 provides a polymer-nanocarbon composite according to any one of embodiments 1 to 18, wherein at least some of the aromatic hydrocarbon moieties and/or aromatic heterocyclic moieties further comprise one or more functional groups comprising one or more of oxygen, nitrogen or sulfur atoms, wherein said functional groups are present as a substituent or within a substituent on an aromatic or aliphatic carbon atom.

Embodiment 20 provides a polymer-nanocarbon composite according to embodiment 19, wherein the one or more functional groups comprise one or more alcohols, aldehydes, amines, amides, acids, alkenes, alkynes, azides, carbonates, esters, ethers, halides, ketones, nitro, phenols, thiols, sulfonyl, and sulfonate.

Embodiment 21 provides a polymer-nanocarbon composite according to any one of embodiments 1 to 20, wherein at least some of the one or more nanocarbon materials are linked to at least some of the aromatic hydrocarbon moieties and/or aromatic heterocyclic moieties via aryl-aryl bonds, aryl-heteroaryl bonds, and combinations thereof.

Embodiment 22 provides a polymer-nanocarbon composite according to any one of embodiments 1 to 21, wherein at least some of the one or more nanocarbon materials are linked to at least some of the aromatic hydrocarbon moieties and/or aromatic heterocyclic moieties via one or more linking groups.

Embodiment 23 provides a polymer-nanocarbon composite according to embodiment 22, wherein the one or more linking groups comprise one or more aromatic rings.

Embodiment 24 provides a polymer-nanocarbon composite according to embodiment 22 or embodiment 23, wherein the one or more linking groups comprise one or more heteroatoms.

Embodiment 25 provides a polymer-nanocarbon composite according to any one of embodiments 1 to 24, wherein the one or more nanocarbon materials further comprise one or more functional groups comprising one or more of oxygen, nitrogen, or sulfur atoms, wherein said functional groups are present as a substituent or within a substituent on an aromatic carbon of the nanocarbon material.

Embodiment 26 provides a polymer-nanocarbon composite according to embodiment 25, wherein the one or more functional groups comprises one or more of alcohols, aldehydes, amines, amides, acids, alkenes, alkynes, azides, arenes, carbonates, esters, ethers, halides, ketones, nitro groups, phenols and thiols.

Embodiment 27 provides a polymer-nanocarbon composite according to any one of embodiments 1 to 26, wherein the one or more nanocarbon materials comprise one or more fibers, yarns, fabrics, mats, papers, and foams.

Embodiment 28 provides a polymer-nanocarbon composite according to any one of embodiments 1 to 27, wherein the one or more polymers is derived from mixed aromatic feedstock.

Embodiment 29 provides a polymer-nanocarbon composite according to embodiment 28, wherein the mixed aromatic feedstock comprises a light aromatic stream, for example including aromatics from catalytic reforming or steam cracking (e g., BT(E)X and pyrolysis gasoline), reformate from catalytic reformers, and/or mixed alkylated naphthalenes.

Embodiment 30 provides a polymer-nanocarbon composite according to embodiment 28, wherein the mixed aromatic feedstock comprises one or more of residues of petrochemical refining or extraction, including vacuum residue, fluidic catalytic cracking (‘FCC’) bottoms (slurry oil, main column bottoms (MCB)), steam cracker tar, asphaltenes, C3-C7 rock, bitumen, K-pot bottoms, lube extracts, various streams from refinery processes and other synthetic aromatic hydrocarbons.

Embodiment 31 provides a polymer-nanocarbon composite according to any one of embodiments 28 to 30, wherein the mixed aromatic feedstock has a H/C ratio less than 1.6, or less than 1.5, or less than 1.4, or less than 1.3, or less than 1.2, or less than 1.0, or less than 0.7.

Embodiment 32 provides a polymer-nanocarbon composite according to any one of embodiments 28 to 31, wherein the mixed aromatic feedstock has an aromatic content of greater than 50% by weight, or greater than about 60% by weight, or greater than about 70% by weight, or greater than about 80% by weight.

Embodiment 33 provides a polymer-nanocarbon composite according to any one of embodiments 28 to 32, wherein the mixed aromatic feedstock comprises one or more transition metals.

Embodiment 34 provides a polymer-nanocarbon composite according to any one of embodiments 1 to 33, wherein the weight average molecular weight of the one or more polymers is greater than about 10,000 Daltons, or greater than about 20,000 Daltons, or greater than about 50,000 Daltons, or greater than about 100,000 Daltons, or greater than about 200,000 Daltons, or greater than about 300,000 Daltons, or great than about 500,000 Daltons, or greater than about 700,000 Daltons, or greater than about 1,000,000 Daltons.

Embodiment 35 provides an article of manufacture comprising a polymer-nanocarbon composite according to any one of embodiments 1 to 34.

Embodiment 36 provides a carbon matrix-nanocarbon composite comprising the pyrolysis product of a polymer-nanocarbon composite according to any one of embodiments 1 to 34.

Embodiment 37 provides a carbon matrix-nanocarbon composite according to embodiment 36, wherein at least 50 wt. %, or at least 55 wt. %, or at least 60 wt. %, or at least 65 wt. %, of the elements present in the carbon matrix-nanocarbon composition is carbon.

Embodiment 38 provides an article of manufacture comprising a carbon matrix-nanocarbon composition according to embodiment 36 or 37.

Embodiment 39 provides a method of preparing a polymer-nanocarbon composite comprising the steps of: (a) combining one or more nanocarbon materials with one or more polymerizable aromatic hydrocarbons and/or one or more polymerizable aromatic heterocyclics; and (b) polymerizing the one or more polymerizable aromatic hydrocarbons and/or polymerizable aromatic heterocyclics.

Embodiment 40 provides a method according to embodiment 39, wherein the method is conducted in the absence or substantial absence of additional solvent over and above the one or more polymerizable aromatic hydrocarbons and/or one or more polymerizable aromatic heterocyclics.

Embodiment 41 provides a method according to embodiment 40, wherein the amount of additional solvent is less than about 10 wt. %, based on the total weight of components in step (a), or less than about 5 wt. %, or less than about 4 wt. %, or less than about 3 wt. %, or less than about 2 wt. %, or less than about 1 wt. %.

Embodiment 42 provides a method according to embodiment 39 or embodiment 40, wherein the additional solvent is a non-aromatic solvent.

Embodiment 43 provides a method according to embodiment 39 or embodiment 40, wherein the additional solvent is an aromatic solvent.

Embodiment 44 provides a method according to any one of embodiments 39 to 43, wherein the additional solvent is a non-polymerizable solvent.

Embodiment 45 provides a method according to any one of embodiments 39 to 44, wherein the additional solvent is non-polymerizable under conditions in which the one or more polymerizable aromatic hydrocarbons and/or one or more polymerizable aromatic heterocyclics are polymerizable.

Embodiment 46 provides a method according to any one of embodiments 39 to 45 further comprising the step of dispersing the one or more nanocarbon materials in the one or more polymerizable aromatic hydrocarbons and/or polymerizable aromatic heterocyclics, prior to polymerization.

Embodiment 47 provides a method according to any one of embodiments 39 to 46, wherein prior to combining one or more nanocarbon materials with one or more polymerizable aromatic hydrocarbons and/or one or more polymerizable aromatic heterocyclics, partial polymerization or oligomerization of the one or more polymerizable aromatic hydrocarbons and/or one or more polymerizable aromatic heterocyclics is performed.

Embodiment 48 provides a method according to any one of embodiments 39 to 47, wherein step (a) further comprises combining one or more linker agents with the one or more nanocarbon materials and one or more polymerizable aromatic hydrocarbons and/or polymerizable aromatic heterocyclics.

Embodiment 49 provides a method according to embodiment 48, wherein the linker agent has the structure of Formula 1:

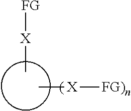

(Formula 1) wherein the circle represent an aliphatic or aromatic moiety; FG (functional group) is, independently, alcohol, aldehyde, amine, amide, carboxylic acid, carboxylic anhydride, acid halide, alkene, alkyne, azide, arene, carbonate, ester, ether, halide, ketone, methylene, nitro, phenol, thiol, tosylate, mesylate, and sulfonate; each X, when present, is, independently, alkylene, cycloalkylene, or arylene bonded to a carbon atom of the aliphatic or aromatic moiety; n is an integer in the range of 1 to 5, or 1 to 10, or 1 to 15, or 1 to 20.

Embodiment 50 provides a method of preparing a carbon matrix-nanocarbon composite, comprising: (a) combining one or more nanocarbon materials with one or more polymerizable aromatic hydrocarbons and/or one or more polymerizable aromatic heterocyclics; (b) polymerizing the one or more polymerizable aromatic hydrocarbons and/or polymerizable aromatic heterocyclics, thereby forming a polymer-nanocarbon composite; and (c) pyrolyzing the polymer-nanocarbon composite.

Embodiment 51 provides a method according to embodiment 50, wherein the polymernanocarbon composite is pyrolyzed at a temperature in the range of from 300 to 1000° C.

Embodiment 52 provides a method according to embodiment 51, wherein, following pyrolysis at a temperature in the range of from 300 to 1000° C., the product is subjected to further thermal treatment at a temperature greater than 1000° C.

Embodiment 53 provides a fiber-reinforced polymer composite (FRP), comprising: one or more polymers comprising aromatic hydrocarbon moieties and/or aromatic heterocyclic moieties, fibers, and one or more nanocarbon materials.

Embodiment 54 provides a fiber-reinforced polymer composite according to embodiment 53, wherein the fibers are selected from the group consisting of glass, carbon, polymer, cellulosic and/or mineral fibers.

Embodiment 55 provides a fiber-reinforced polymer composite according to embodiment 53 or 54, wherein the one or more nanocarbon materials are dispersed in the polymeric phase of the composite.

Embodiment 56 provides a fiber-reinforced polymer composite according to any one of embodiments 53 to 55, wherein the one or more nanocarbon materials are distributed throughout the polymeric phase of the composite.

Embodiment 57 provides a fiber-reinforced polymer composite according to any one of embodiments 53 to 56, wherein the one or more nanocarbon materials are physically or chemically immobilized/attached on the surface of fibers.

Embodiment 58 provides an article of manufacture comprising a fiber-reinforced polymer composite according to any one of embodiments 53 to 57.

Embodiment 59 provides a fiber-reinforced carbon matrix-nanocarbon composite comprising the pyrolysis product of a fiber-reinforced polymer composite according to any one of embodiments 53 to 58.

Embodiment 60 provides a fiber-reinforced carbon matrix-nanocarbon composite according to embodiment 59, wherein at least 50 wt. %, or at least 55 wt. %, or at least 60 wt. %, or at least 65 wt. %, of the elements present in the carbon matrix-nanocarbon composition is carbon.

Embodiment 61 provides an article of manufacture comprising a fiber-reinforced carbon matrix-nanocarbon composite according to embodiment 59 or embodiment 60.

Embodiment 62 provides a method of preparing a fiber-reinforced polymer composite comprising the steps of: (a) combining fibers, one or more nanocarbon materials, and one or more polymerizable monomers, wherein the polymerizable monomers are selected from the group consisting of a polymerizable aromatic hydrocarbon and a polymerizable aromatic heterocyclic; and (b) polymerizing the one or more polymerizable monomers.

Embodiment 63 provides a method according to embodiment 62, wherein the fibers are selected from the group consisting of glass, carbon, polymer, cellulosic and/or mineral fibers.

Embodiment 64 provides a method according to embodiment 62 or embodiment 63, wherein the one or more nanocarbon materials are combined with the polymerizable monomer, prior to combining with the fibers.

Embodiment 65 provides a method according to any one of embodiments 62 to 64, wherein the one or more nanocarbon materials are dispersed in the one or more polymerizable monomers, prior to combining with the fibers.

Embodiment 66 provides a method according to any one of embodiments 62 to 65, wherein the one or more nanocarbon materials are distributed throughout the one or more polymerizable monomers, prior to combining with the fibers.

Embodiment 67 provides a method according to any one of embodiments 62 to 66, wherein the one or more nanocarbon materials are coated with the polymerizable monomer, prior to combining with the fibers.

Embodiment 68 provides a method according to any one of embodiments 62 to 67, wherein the one or more nanocarbon materials are physically or chemically immobilized/attached on the surface of fibers, prior to combining with the one or more polymerizable monomers.

Embodiment 69 provides a method of preparing a fiber-reinforced carbon matrix-nanocarbon composite comprising (a) combining fibers, one or more nanocarbon materials, and one or more polymerizable monomers, wherein the polymerizable monomers are selected from the group consisting of a polymerizable aromatic hydrocarbon and a polymerizable aromatic heterocyclic; (b) polymerizing the one or more polymerizable monomers, thereby forming a fiber-reinforced polymernanocarbon composite; and (c) pyrolyzing the fiber-reinforced polymer-nanocarbon composite.

Embodiment 70 provides a method according to embodiment 69, wherein the polymer-nanocarbon composite is pyrolyzed at a temperature in the range of from 300 to 1000° C.

Embodiment 71 provides a method according to embodiment 71 wherein, following pyrolysis at a temperature in the range of from 300 to 1000° C., the product is subjected to further thermal treatment at a temperature greater than 1000° C.

All patents, patent applications and other documents cited herein are fully incorporated by reference to the extent such disclosure is not inconsistent with this disclosure and for all jurisdictions in which such incorporation is permitted.

Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the compositions and methods of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A polymer-nanocarbon composite, said polymer-nanocarbon composite comprising one or more nanocarbon materials and one or more polymers, said polymers comprising aromatic hydrocarbon moieties and/or aromatic heterocyclic moieties.

2. A polymer-nanocarbon composite according to claim 1, wherein the one or more nanocarbon materials comprise one or more of carbon nanotubes, carbon nanofibers, graphene, fullerenes, activated carbon, carbon black, carbon foams, and articles made therefrom.

3. A polymer-nanocarbon composite according to claim 1, wherein the one or more nanocarbon materials are dispersed within the polymer-nanocarbon composite.

4. A polymer-nanocarbon composite according to claim 1, wherein the one or more nanocarbon materials are distributed throughout the polymer-nanocarbon composite.

5. A polymer-nanocarbon composite according to claim 1, wherein the amount of the one or more nanocarbon materials is up to about 70 vol. %, based on the total volume of the polymer-nanocarbon composite.

6. A polymer-nanocarbon composite according to claim 1, wherein the one or more nanocarbon materials have at least one dimension in a size ranging from about 0.2 nm to about 100 nm.

7. A polymer-nanocarbon composite according to claim 1, wherein the polymer-nanocarbon composite has a void fraction of less than about 5 vol. % based on the total volume of the polymer-nanocarbon composite.

8. A polymer-nanocarbon composite according to claim 1, wherein the amount of volatiles in the polymer-nanocarbon composite is less than about 10 wt. %.

9. A polymer-nanocarbon composite according to claim 1, wherein the amount of extractables in the polymer-nanocomposite is less than about 10 wt. %.

10. A polymer-nanocarbon composite according to claim 1, wherein the composite is derived from a composition comprising one or more nanocarbon materials and one or more aromatic hydrocarbons and/or aromatic heterocyclics, wherein said composition comprises less than about 10 wt. % solvent, based on the total weight of nanocarbon materials, one or more aromatic hydrocarbons and/or aromatic heterocyclics, and solvent.

11. A polymer-nanocarbon composite according to claim 1, wherein the aromatic hydrocarbon moieties and aromatic heterocyclic moieties comprise one or more monocyclic aromatic moieties, one or more polycyclic aromatic moieties and mixtures thereof.

12. A polymer-nanocarbon composite according to claim 1, wherein the one or more polymers comprise a plurality of different monocyclic aromatic moieties and/or polycyclic aromatic moieties.

13. A polymer-nanocarbon composite according to claim 1, wherein the average molecular weight of aromatic hydrocarbon moieties and/or aromatic heterocyclic moieties is between about 50 Daltons and about 1200 Daltons.

14. A polymer-nanocarbon composite according to claim 1, wherein the one or more aromatic hydrocarbon moieties and/or aromatic heterocyclic moieties are linked via ary 1-ary 1 bonds, arylheteroaryl bonds, heteroaryl-heteroaryl bonds and combinations thereof.

15. A polymer-nanocarbon composite according to claim 1, wherein the one or more aromatic hydrocarbon moieties and/or aromatic heterocyclic moieties are linked via one or more linking groups.

16. A polymer-nanocarbon composite according to claim 1, wherein the one or more aromatic heterocyclic moieties comprise one or more ring atoms selected from the group consisting of nitrogen, sulfur, and oxygen.

17. A polymer-nanocarbon composite according to claim 1, wherein at least some of the aromatic hydrocarbon moieties and/or aromatic heterocyclic moieties further comprise one or more functional groups comprising one or more of oxygen, nitrogen, or sulfur atoms, wherein said functional groups are present as a substituent or within a substituent on an aromatic or aliphatic carbon atom.

18. A polymer-nanocarbon composite according to claim 1, wherein at least some of the one or more nanocarbon materials are linked to at least some of the aromatic hydrocarbon moieties and/or aromatic heterocyclic moieties via aryl-aryl bonds, aryl-heteroaryl bonds, and combinations thereof.

19. A polymer-nanocarbon composite according to claim 1, wherein at least some of the one or more nanocarbon materials are linked to at least some of the aromatic hydrocarbon moieties and/or aromatic heterocyclic moieties via one or more linking groups.

20. A polymer-nanocarbon composite according to claim 1, wherein the one or more nanocarbon materials further comprise one or more functional groups comprising one or more of oxygen, nitrogen, or sulfur atoms, wherein said functional groups are present as a substituent or within a substituent on an aromatic carbon of the nanocarbon material.

21. A polymer-nanocarbon composite according to claim 1, wherein the weight average molecular weight of the one or more polymers is greater than about 10,000 Daltons.

22. An article of manufacture comprising a polymer-nanocarbon composite according to claim 1.

23. A method of preparing a polymer-nanocarbon composite comprising the steps of:
(a) combining one or more nanocarbon materials with one or more polymerizable aromatic hydrocarbons and/or one or more polymerizable aromatic heterocyclics; and
(b) polymerizing the one or more polymerizable aromatic hydrocarbons and/or polymerizable aromatic heterocyclics.

24. A method according to claim 23, wherein the method is conducted in the absence or substantial absence of additional solvent over and above the one or more polymerizable aromatic hydrocarbons and/or one or more polymerizable aromatic heterocyclics.

25. A method according to claim 23, wherein the amount of additional solvent is less than about 10 wt. %, based on the total weight of components in step (a).
